(19) United States
(12) Patent Application Publication
(10) Pub. No.: US 2025/0128783 A1
(43) Pub. Date: Apr. 24, 2025

(54) HEADSET CABLE ROUTER

(71) Applicant: SRAM, LLC, CHICAGO, IL (US)

(72) Inventors: CHARLES DUNLAP, COLORADO SPRINGS, CO (US); KEVIN WESLING, LOMBARD, IL (US)

(73) Assignee: SRAM, LLC, CHICAGO, IL (US)

(21) Appl. No.: 18/915,789

(22) Filed: Oct. 15, 2024

Related U.S. Application Data
(60) Provisional application No. 63/592,062, filed on Oct. 20, 2023.

(51) Int. Cl. B62K 23/02; B62K 21/06

(52) U.S. Cl. CPC B62K 23/02; B62K 21/06

(57) ABSTRACT

A control line router for a headset of a bicycle includes a barrier disposed between a component of the bicycle and a segment of a control line within a headtube of the bicycle.

This application claims priority to U.S. Provisional Patent Application 63/592,062, filed Oct. 20, 2023, the contents of which are hereby incorporated by reference in its entirety.

### FIELD OF THE DISCLOSURE

The present disclosure is generally directed to cable routing for a bicycle, and more particularly, to internal cable routing via a headset of a bicycle.

### DESCRIPTION OF RELATED ART

Internally routed control lines of a bicycle, including, for example, hydraulic hose, derailleur line(s) (e.g., metal-reinforced derailleur line(s)), brake line(s) (e.g., including a cable and housing), and/or electrical conductors, may enter a head tube of a frame of the bicycle via a stem or a headset attached to the frame. The control lines may run between an inner surface of the head tube and an outer surface of a steerer tube of a fork that is rotatably attached to the frame via the headset. The control lines extend through the head tube and exit the head tube into a top tube of the frame or a down tube of the frame. The control lines may be control lines for operating, for example, brake(s), derailleur(s), a dropper seat post, suspension controls, and/or sensors.

### SUMMARY

An example control line router for a headset of a bicycle has a barrier disposed between a component of the bicycle and a segment of a control line within a headtube of the bicycle.

Another example is a device a bicycle having a barrier disposed between one or more components in a headtube of the bicycle.

### BRIEF DESCRIPTION OF THE DRAWINGS

Objects, features, and advantages of the present invention will become apparent upon reading the following description in conjunction with the drawing figures, in which:

FIG. 1 is a side view of one example of a bicycle that may be fitted with a headset cable router in accordance with the teachings of this disclosure;

FIG. 2 is an exploded perspective view of components of the bicycle of FIG. 1 including a first embodiment of the headset cable router;

FIG. 3 is a close-up of the exploded perspective view of components of the first embodiment of the headset cable router of FIG. 2;

FIG. 4 is a first top view of a frame and fork assembly of the components of FIG. 2;

FIG. 5 is a close-up of the top view of the frame and fork assembly of FIG. 4;

FIG. 6 is a first side view of the frame and fork assembly of FIG. 4;

FIG. 7 is a close-up of the side view of the frame and fork assembly of FIG. 6;

FIG. 8 is a cross-section of the side view of the frame and fork assembly of FIG. 6, illustrating internal cable routing using the first embodiment of the headset cable router;

FIG. 9 is a close-up of the cross-section of FIG. 8;

FIG. 10 is a front view of the frame and fork assembly of FIG. 4;

FIG. 11 is a second top view of the frame and fork assembly of FIG. 4;

FIG. 12 is a cross-section of the frame and fork assembly of FIG. 11 taken along axis A-A of FIG. 11;

FIG. 13 is a close-up of the cross-section of FIG. 12;

FIG. 14 is a second side view of the frame and fork assembly of FIG. 4;

FIG. 15 is a cross-section of the frame and fork assembly of FIG. 14 taken along axis B-B of FIG. 14;

FIG. 16 is a close-up of the cross-section of FIG. 15;

FIG. 17 is a perspective view of a steerer sheath of the first embodiment of the headset cable router of FIG. 2;

FIG. 18 is a top view of the steerer sheath of FIG. 17;

FIG. 19 is a side view of the steerer sheath of FIG. 17;

FIG. 20 is a cross-section of the steerer sheath of FIG. 19 taken along axis C-C of FIG. 19;

FIG. 21 is an exploded perspective view of components of the bicycle of FIG. 1 including a second embodiment of the headset cable router;

FIG. 22 is a close-up of the exploded perspective view of components of the second embodiment of the headset cable router of FIG. 21;

FIG. 23 is a cross-section of a side view of a frame and fork assembly of the components of FIG. 21, illustrating internal cable routing using the second embodiment of the headset cable router;

FIG. 24 is a close-up of the cross-section of FIG. 23;

FIG. 25 is a front view of the frame and fork assembly of FIG. 23;

FIG. 26 is a top view of the frame and fork assembly of FIG. 23;

FIG. 27 is a cross-section of the frame and fork assembly of FIG. 26 taken along axis D-D of FIG. 26;

FIG. 28 is a close-up of the cross-section of FIG. 27;

FIG. 29 is a side view of the frame and fork assembly of FIG. 23;

FIG. 30 is a cross-section of the frame and fork assembly of FIG. 29 taken along axis E-E of FIG. 29;

FIG. 31 is a close-up of the cross-section of FIG. 30;

FIG. 32 is a perspective view of a line sheath of the second embodiment of the headset cable router of FIG. 21;

FIG. 33 is a top view of the line sheath of FIG. 32;

FIG. 34 is a side view of the line sheath of FIG. 32; and

FIG. 35 is a cross-section of the line sheath of FIG. 34 taken along axis F-F of FIG. 34.

### DETAILED DESCRIPTION OF THE DISCLOSURE

The control lines for operating, for example, brakes, derailleur(s), a dropper seat post, suspension controls, and/or sensors of a bicycle may be anchored at one end to a handlebar of the bicycle, and anchored at the other end to a frame of the bicycle. Due to this anchoring of the control lines at both ends, steering maneuvers (e.g., of the handlebar and the fork relative to the frame) cause movement of the control lines relative to steering anchored parts (e.g., a steerer tube of a fork, a stem) and frame anchored parts (e.g., a head tube of the frame, part of a headset). This movement of the control lines may cause line friction and wear against adjacent parts (e.g., at least some of the steering anchored parts and/or the frame anchored parts).

The present disclosure provides examples of headset cable routers that solve or improve upon one or more disadvantages with prior known internal cable routing within a bicycle. The disclosed headset cable routers include ports on a headset cap of the headset, such that the control lines are routed past the stem and into the frame of the bicycle via the ports on the headset cap.

In an embodiment, the headset cable router includes a barrier to protect control lines, components, and frame members from each other. In one embodiment, the barrier is disposed between components of a bicycle within a headtube of the bicycle. The components may include, but are not limited to, a steerer tube of a bicycle, a control line or segment of the control line, or any other part that is normally disposed, at least partially, within the headtube of the bicycle.

In another embodiment a barrier is flexible.

In another embodiment, where a component of the bicycle is a steerer tube of a fork, a barrier is configured to surround, at least in part, the steerer tube. In an embodiment, the barrier may be a tapered tube offset from the steerer tube, the tapered tube configured so that the tapered tube does not contact the steerer tube. In another embodiment, the barrier is attached to any one or both of an upper cup and a lower cup of the headset of the bicycle. In yet another embodiment, the barrier contacts the steerer tube.

In another embodiment of the control line router, a barrier is configured to surround a segment of a control line. In this embodiment, the barrier may extend into a top tube, a down tube, a stem, a fork, or any combination of the top tube, down tube, stem, or fork.

In another embodiment of the control line router, a barrier has an annular cross section. In this embodiment, the barrier may include a seam along a length of the barrier.

In another embodiment of the control line router, a barrier has a steerer tube sheath configured to surround, at least in part, a steerer tube of a fork, and a control line sheath configured to surround, at least in part, the segment of the control line.

In another embodiment of the control line router, a barrier is made of one or a combination of a plastic, a polymer, a carbon fiber composite, a composite, PTFE, an elastic material, or a metal.

In another embodiment of the control line router, a barrier has an outer wall, the outer wall including a friction reducing coating, wherein the friction reducing coating comprises any one or a combination of a PTFE coating, a wet lubricant, or a dry lubricant.

In another embodiment the control line router has a cap through which extends a steerer tube of a fork, the cap having one or more ports extending through the cap, wherein the control line extends through the cap via the one or more ports.

In another embodiment of the control line router has an upper cup having a clearance configured to allow for radial and/or rotational clearance for the control line.

In another embodiment, a control line is a hydraulic tube or a bowden cable.

In another embodiment, a device for a bicycle has a barrier disposed between one or more components in a headtube of the bicycle.

In an embodiment, the device is a barrier configured to surround a section of the steerer tube

In an embodiment, the device is a barrier configured to surround a segment of the control line.

In a embodiment, the device is a barrier having at least two sheaths, where a first sheath is configured to surround a section of a steerer tube of a fork, and a second sheath is configured to surround a segment of a control line.

In another embodiment, the barrier is a sheath. The sheath is configured to act as a barrier between components of a bicycle.

It will be understood that a sheath is a type of barrier. Other types of barriers, including, but not limited to, wraps, covers, shields, curtains, sheets, walls, etc., can also be contemplated without departing from the scope of this disclosure.

In one embodiment, a sheathing system of a headset cable router includes a steerer sheath that is disposed around a portion of the steerer tube of the fork. The steerer sheath may be a hollow cylinder (e.g., have an annular cross section) and may be thin walled. In one embodiment, the steerer sheath may be tapered and closely offset from the steerer tube, such that radial clearances and head tube access are maximized. In another embodiment, the steerer sheath is non-tapered and/or is in contact with the steerer tube.

The steerer sheath may be made of any number of materials including, for example, plastic, polytetrafluoroethylene (PTFE), carbon fiber, polymer, an elastic material, a smooth metal, or another material. The steerer sheath may be rigid or flexible. In one embodiment, a wet or dry lubricant is applied to an outer surface of the steerer sheath. The steerer sheath may be fixedly or rotationally attached to an upper cup and/or a lower cup of the headset.

The steerer sheath creates a low friction barrier between the steerer tube of the fork and the control lines. With the steerer sheath positioned around the portion of the steerer tube of the fork, the control lines may not rub or wear against the steerer tube. This may prevent loss of communication between one or more control devices of the bicycle and one or more components of the bicycle (e.g., derailleur(s), brake(s), sensor(s)).

In another embodiment, a sheathing system of a headset cable router includes a one or more line sheaths that are disposed around portions of one or more control lines, respectively. A line sheath of the one or more line sheaths may be a hollow cylinder (e.g., have an annular cross section) and may be thin walled. In one embodiment, the line sheath is in contact with the respective control line.

The line sheath may be made of any number of materials including, for example, plastic, polytetrafluoroethylene (PTFE), carbon fiber, polymer, an elastic material, a smooth metal, or another material. The line sheath may be rigid or flexible. In one embodiment, a wet or dry lubricant is applied to an outer surface of the line sheath. The line sheath may be fixedly or rotationally attached to the upper cup and/or the lower cup of the headset.

The line sheath creates a low friction barrier between the steerer tube of the fork and the respective control line. With the line sheath positioned around the portion of the respective control line, the respective control line may not rub or wear against the steerer tube. This may prevent loss of communication between one or more control devices of the bicycle and one or more components of the bicycle (e.g., derailleur(s), brake(s), sensor(s)).

In another embodiment, a sheathing system of a headset cable router includes a steerer sheath disposed around a portion of the steerer tube of the fork, and one or more line sheaths disposed around portions of one or more control lines, respectively. The combination of the steerer sheath and the one or more line sheaths acts as a double barrier against friction and wear.

The disclosed headset cable routers may also include a clearance within the upper cup of the headset. For example, the upper cup of the headset may be a hollow cylinder with a varied inner diameter (e.g., and a varied outer diameter). For example, an inner surface (e.g., an inner annular surface) of the of the upper cup may be beveled at and adjacent to an end of the upper cup. The bevel provides the clearance. The clearance within the upper cup of the headset allows the control lines to move radially and circumferentially freely with rotation of the steerer tube of the fork relative to the frame of the bicycle.

These and other objects, features, and advantages of the disclosed control devices will become apparent to those having ordinary skill in the art upon reading this disclosure. Throughout the drawing figures, where like reference numbers are used, the like reference numbers represent the same or substantially similar parts among the various disclosed examples. Also, specific examples are disclosed and described herein that utilize specific combinations of the disclosed aspects, features, and components of the disclosure. However, it is possible that each disclosed aspect, feature, and/or component of the disclosure may, in other examples not disclosed or described herein, be used independent of or in different combinations with other of the aspects, features, and components of the disclosure.

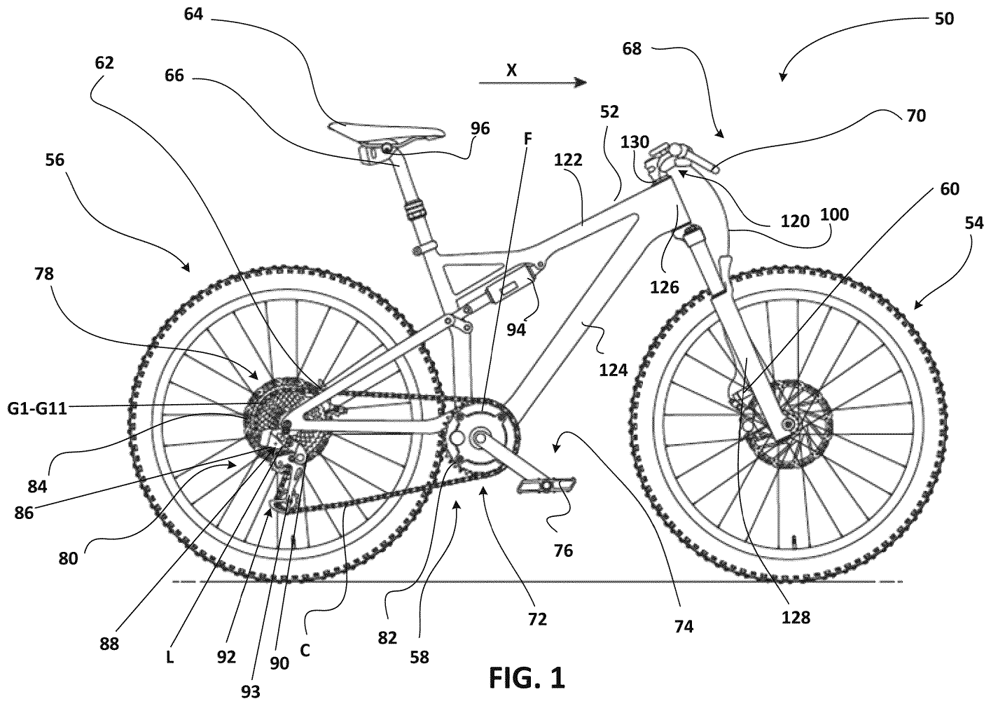

Turning now to the drawings, FIG. 1 generally illustrates a bicycle 50 that employs a headset cable router constructed in accordance with the teachings of the present disclosure. The bicycle 50 includes a frame 52, a front wheel 54 and a rear wheel 56 each rotatably attached to the frame 52, and a drivetrain 58. A front brake 60 is provided for braking the front wheel 54, and a rear brake 62 is provided for braking the rear wheel 56. The bicycle 50 also generally has a seat 64 near a rear end of the frame 52 and carried on an end of a seat post 66 connected to the frame 52. The bicycle 50 also has handlebars 68 near a forward end of the frame 52. A brake lever 70 is carried on the handlebars 68 for actuating the front brake 60, the rear brake 62, or both the front brake 60 and the rear brake 62. If the brake lever 70 actuates only one of the front brake 60 and the rear brake 62, a second brake lever (not shown) may also be provided to actuate the other brake. A front and/or forward riding direction or orientation of the bicycle 50 is indicated by the direction of the arrow X in FIG. 1. As such, a forward direction for the bicycle 50 is indicated by the direction of arrow A. While the illustrated bicycle 50 depicted in FIG. 1 is a mountain bike with flat handlebars 68, the present disclosure may be applicable to bicycles of any type, including road bikes having drop-style handlebars.

The drivetrain 58 has a chain C and a front sprocket assembly 72, which is coaxially mounted with a crank assembly 74 having pedals 76. The drivetrain 58 also includes a rear sprocket assembly 78 coaxially mounted with the rear wheel 56 and a rear gear change mechanism, such as a rear derailleur 80.

As is illustrated in FIG. 1, the front sprocket assembly 72 may include one or more coaxially mounted chainrings, gears, or sprockets. In this example, the front sprocket assembly 72 has one sprocket F. The one sprocket F has teeth 82 around a respective circumference. As shown in FIG. 1, the rear sprocket assembly 78 may include a plurality of coaxially mounted gears, cogs, or sprockets G. Each sprocket G1-G11 also has teeth 84 arranged around a respective circumference. The number of teeth 84 on the rear sprockets G1-G11 may gradually decrease from the largest diameter rear sprocket G1 to the smallest diameter sprocket G11. Though not described in any detail herein, a front gear changer may be operated to move from a first operating position to a second operating position to move the chain C between front sprockets F. Likewise, the rear derailleur 80 may be operable to move between different operating positions to switch the chain C to a selected one of the rear sprockets G1-G11. In an embodiment, the rear sprocket assembly 78 may have more or fewer sprockets G. For example, in an embodiment, the rear sprocket assembly 78 may have twelve or thirteen sprockets. Dimensions and configuration of the rear derailleur 80 may be modified to accommodate a specific implemented plurality of sprockets. For example, an angle and length of a linkage and/or a configuration of a cage of the rear derailleur 80 may be modified to accommodate specific sprocket combinations.

The rear derailleur 80 is depicted as a wireless, electrically actuated rear derailleur mounted or mountable to the frame 52, or frame attachment, of the bicycle 50. The electric rear derailleur 80 has a base member 86 (e.g., a b-knuckle) that is mounted to the bicycle frame 52. A linkage 88 has two links L that are pivotally connected to the base member 86 at a base member linkage connection portion. A movable member 90 (e.g., a p-knuckle) is connected to the linkage 88 at a moveable member linkage connection portion. A chain guide assembly 92 (e.g., a cage) is configured to engage and maintain tension in the chain and has one or more cage plates 93 with a proximal end that is pivotally connected to a part of the movable member 90. The cage plate 93 may rotate or pivot about a cage rotation axis in a damping direction and a chain tensioning direction. Other gear changing systems, such as mechanically or hydraulically controlled and/or actuated systems may also be used.

A motor module may be carried on the electric rear derailleur 80 with a battery 89. The battery 89 supplies power to the motor module. In one example, the motor module is located in the movable member 90. However, the motor module may instead be located elsewhere, such as in one of the links L of the linkage 88 or in the base member 86. The motor module may include a gear mechanism or transmission. As is known in the art, the motor module and gear mechanism may be coupled with the linkage 88 to laterally move the cage plate 93 and thus switch the chain C among the rear sprockets (e.g., G1-G11) on the rear sprocket assembly 78.

The cage plate 93 also has a distal end that carries a tensioner cog or wheel. The wheel also has teeth around a circumference. The cage plate 93 is biased in a chain tensioning direction to maintain tension in the chain C. The chain guide assembly 92 may also include a second cog or wheel, such as a guide wheel disposed nearer the proximal end of the cage plate 93 and the movable member 90. In operation, the chain C is routed around one of the rear sprockets (e.g., G1-G11). An upper segment of the chain C extends forward to the front sprocket assembly 72 and is routed around the one front sprocket F. A lower segment of the chain C returns from the front sprocket assembly 72 to the tensioner wheel and is then routed forward to the guide wheel. The guide wheel directs the chain C to the rear sprockets (e.g., G1-G11). Lateral movement of the cage plate 93, the tensioner wheel, and the guide wheel may determine the lateral position of the chain C for alignment with a selected one of the rear sprockets (e.g., G1-G11).

The bicycle 50 may include one or more bicycle control devices mounted to handlebars 68. The bicycle control devices may include one or more types of bicycle control and/or actuation systems. For example, the bicycle control devices may include brake actuation systems to control the front brake 60 and/or the rear brake 62, and/or gear shifting systems to control the drivetrain 58. Other control systems may also be included. For example, the system may be applied, in some embodiments, to a bicycle where only a front or only a rear gear changer is used. Also, the one or more bicycle control devices may also include a suspension control system for a suspension 94 (e.g., a front suspension system) of the bicycle 50, a seat post control system for a height adjustable seat post assembly 96, and/or other control systems for the bicycle 50.

Components of the bicycle 50 may be controlled via one or more control lines 100 (e.g., control lines). The control lines 100 may be any number of different types of control lines including, for example, cable housings, Bowden cables, hydraulic hoses, and/or electric wires with which any number of different components of the bicycle 50, including, for example, the rear derailleur 80, the rear brake 62, the front suspension 94, and/or the height adjustable seat post assembly 96, are controlled.

The control lines 100 are routed into the frame 52 of the bicycle with a headset cable router 120. The frame 52 includes a top tube 122 and a down tube 124 rigidly attached to a head tube 126 of the frame 52. The front wheel 54 is rotatably attached to a fork 128, and the fork 128 is rotatably (e.g., pivotably) attached to the frame 52 (e.g., the head tube 126 of the frame 52) with a headset 130. The headset cable router 120 includes ports 132 within the headset 130, via which the control lines 100 are introduced into the frame 52 of the bicycle 50 (e.g., the head tube 126 and the down tube 124 of the bicycle 50). At least one of the control lines 100 may be attached, at one end, to the handlebars 68 (e.g., via a bicycle control device) and, at the other end, to the frame 52 or a frame component.

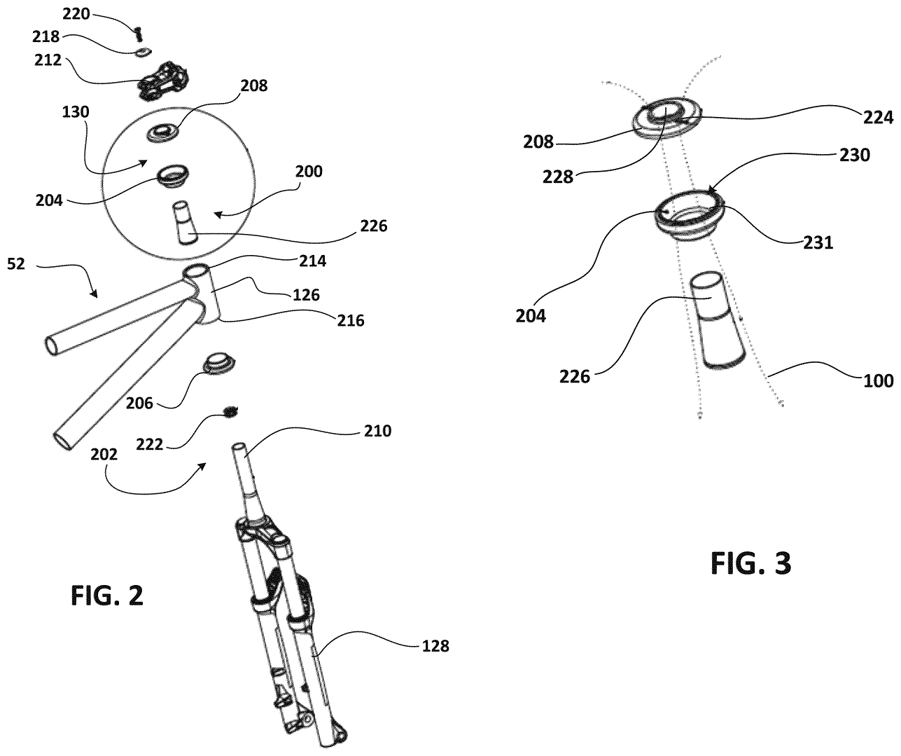

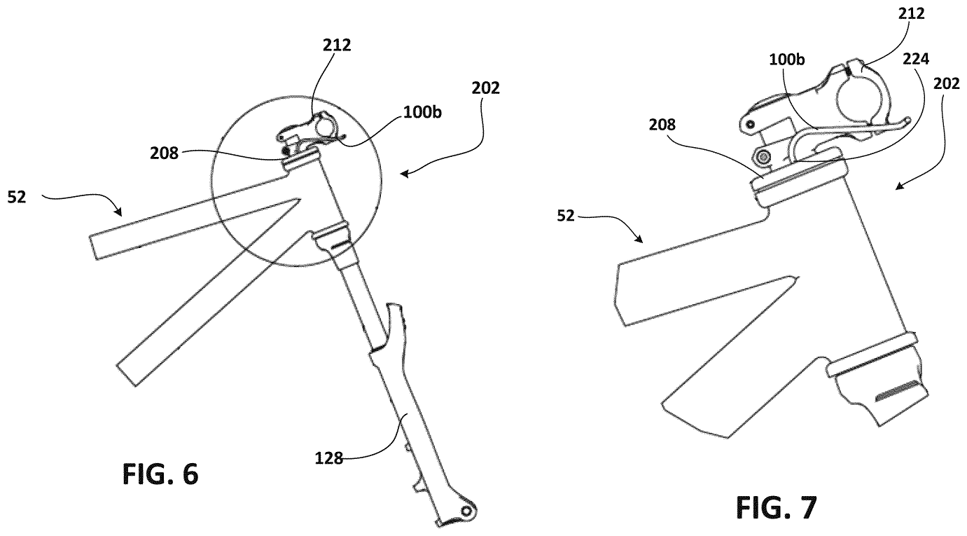

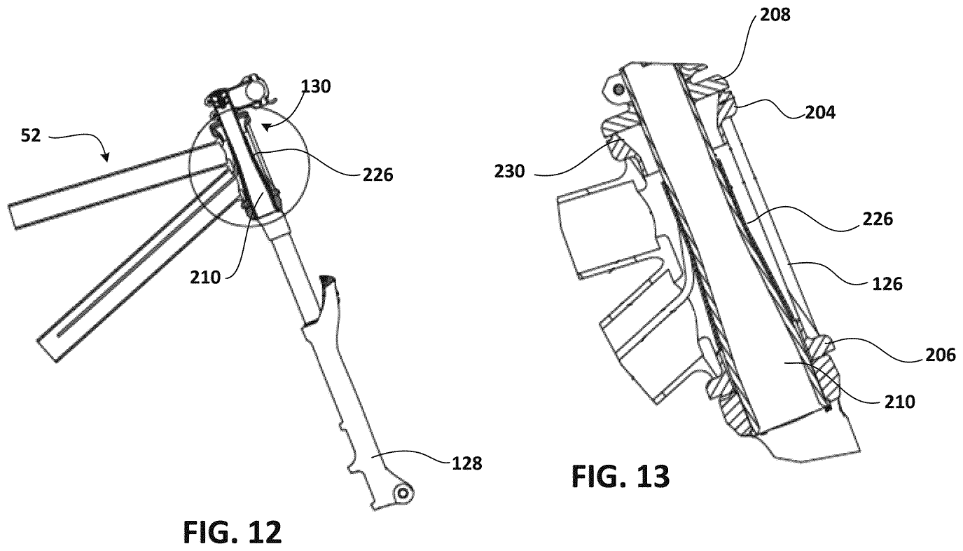

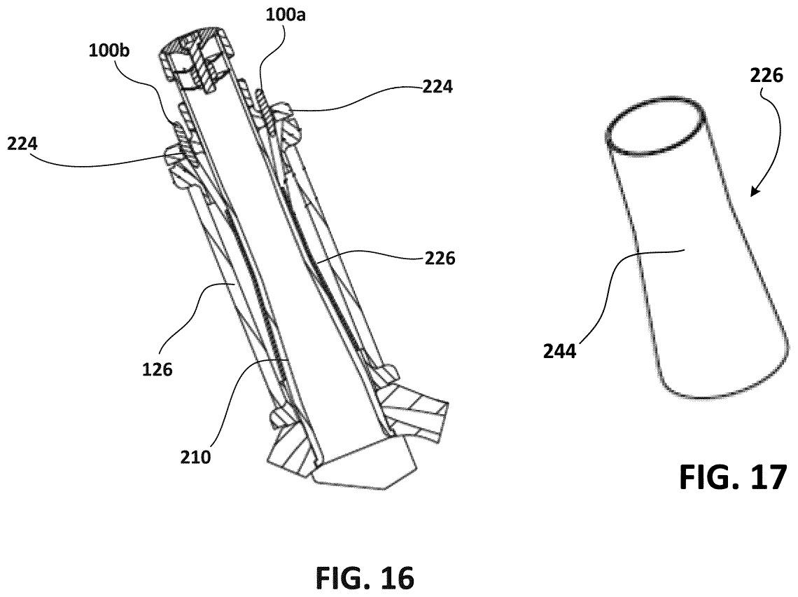

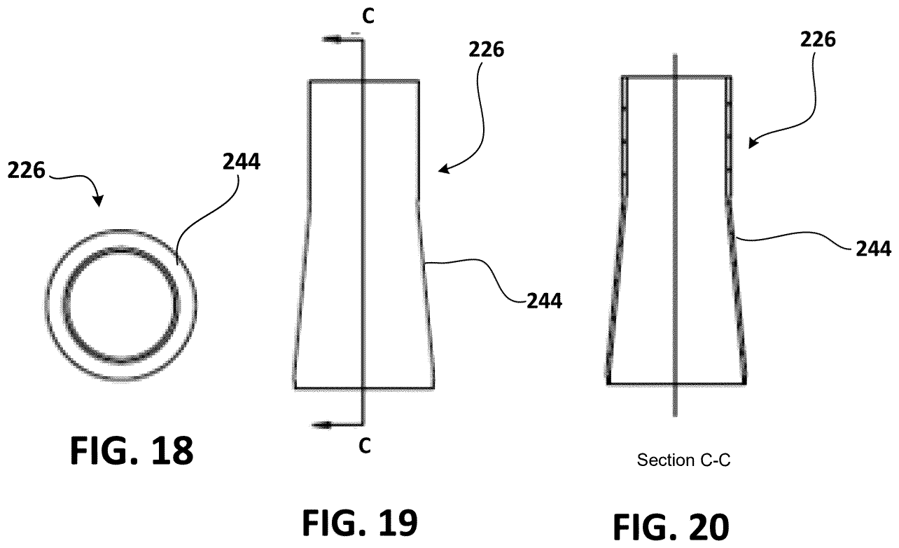

FIGS. 2-20 illustrate a first embodiment of a headset cable router 200 that may be used to route the control lines 100 into and through at least a portion of the frame 52 of the bicycle 50. Referring to FIG. 2, a steering assembly 202 of the bicycle 50, for example, includes the fork 128, the headset 130, and a portion (e.g., the head tube 126) of the frame 52 of the bicycle 50. The fork 128 is rotatably attachable to the frame 52 (e.g., the head tube 126 of the frame 52) with the headset 130.

The headset 130 includes an upper cup 204, a lower cup 206, and a headset cap 208. Each of the upper cup 204 and the lower cup 206 includes bearings that allow for low friction rotation of the fork 128 within the frame 52 (e.g., the head tube 126 of the frame 52) of the bicycle 50. The fork 128 includes a steerer tube 210 that is positionable through the headset 130 and the frame 52 (e.g., the head tube 126 of the frame 52) of the bicycle 50, and a stem 212 is fixedly attachable to a portion of the steerer tube 210 extending through the head tube 126 of the frame 52, for example. The stem 212 is configured to connect the handlebars 68 (not shown) to the fork 128 such that rotation of the handlebars 68 relative to the frame 52 causes rotation of the fork 128, and thus the front wheel 54, relative to the frame 52.

The headset 130 may be attached to the frame 52 (e.g., the head tube 126 of the frame 52) in any number of ways. For example, the upper cup 204 may be attached to a top 214 of the head tube 126, and the lower cup 206 may be attached to a bottom 216 of the head tube 126 using, for example, a top cap 218 and a fastener. The fastener may include, for example, a bolt 220 (e.g., a top cap bolt) and a nut 222 (e.g., a star nut). The star nut 222 may be positioned within the steerer tube 210 of the fork 128, and the top cap 218 and the top cap bolt 220 may be used to compress the headset 130 and the stem 212 (e.g., a pivotable attachment) to the frame 52 (e.g., the head tube 126 of the frame 52). The top cap bolt 220 may engage with the star nut 222 within the steerer tube 210 of the fork 128 to provide the compression. The provided compression may be to a preload for proper function of the headset 130.

The headset cable router 200 includes one or more ports 224 through the headset cap 208, and a sheath 226 (e.g., a steerer sheath). Referring to FIG. 3, in the embodiment, shown, the headset cap 208 includes two ports 224. In other embodiments, the headset cap 208 includes more or fewer ports 224. In the embodiment shown in FIG. 3, the two ports 224 extend through the headset cap 208 on opposite sides of an opening 228 through the headset cap 208, through which the steerer tube 210 of the fork 128 extends. In other embodiments, the ports 224 may extend through the headset cap 208 and be adjacent each other at a front (e.g., towards a front of the stem 212) or a back (e.g., towards a back of the stem 212) of the headset cap 208.

The steerer sheath 226 is disposed around the steerer tube 210 of the fork 128, and is disposed within the head tube 126 of the frame 52. In other words, the steerer sheath 226 covers at least part of a portion of the steerer tube 210 positioned within (e.g., rotatable within) the head tube 126 of the frame 52.

In the embodiment shown in FIG. 3, the headset cable router 200 also includes a clearance 230 in the upper cup 204 (e.g., an upper cup clearance). The upper cup clearance 230 allows for radial and rotational clearance for the control lines 100 to move freely with rotation of the fork 128, and thus the steerer tube 210 of the fork 128, relative to the frame 52 of the bicycle 50. The upper cup clearance 230 may be configured in any number of different ways. For example, the upper cup clearance 230 may be formed by a bevel at and adjacent to an inner edge 231 (e.g., inner circumferential edge) of the upper cup 204.

FIG. 3 shows an example installation of the control lines 100. The control lines 100 extend through the ports 224 in the headset cap 208, through the upper cup clearance 230, and along an outer surface of the steerer sheath 226.

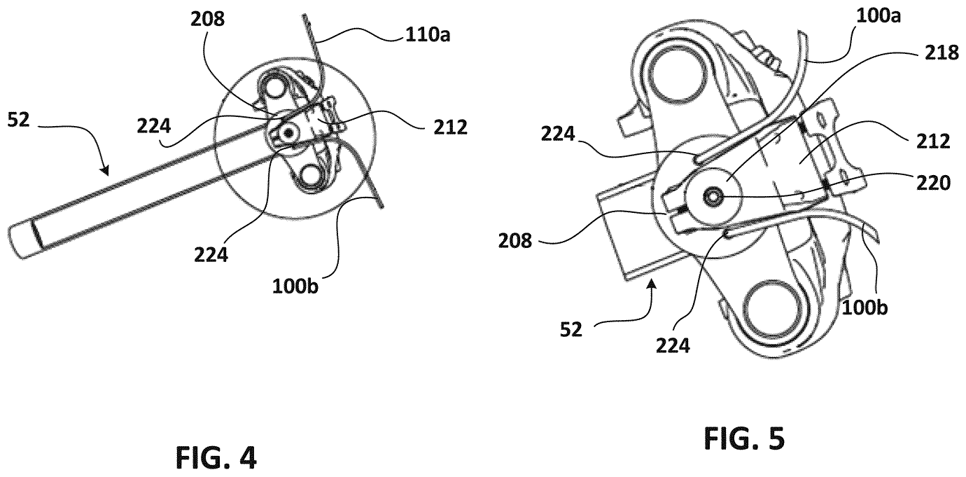

FIGS. 4-7 show components of the steering assembly 202 assembled, and routing of the control lines 100 into the frame 52 of the bicycle 50 via the ports 224 through the headset cap 208. A first control line 100a and a second control line 100b are routed past the stem 212, on opposite sides of the stem 212, and into the ports 224 in the headset cap 208. The bicycle 50 shown in the embodiment of FIGS. 4-7 includes two control lines 100a, 100b extending through the headset cap 208. In other embodiments, more (e.g., three or more) or fewer (e.g., one) control lines may extend into the frame 52 of the bicycle 50 via the headset cap 208.

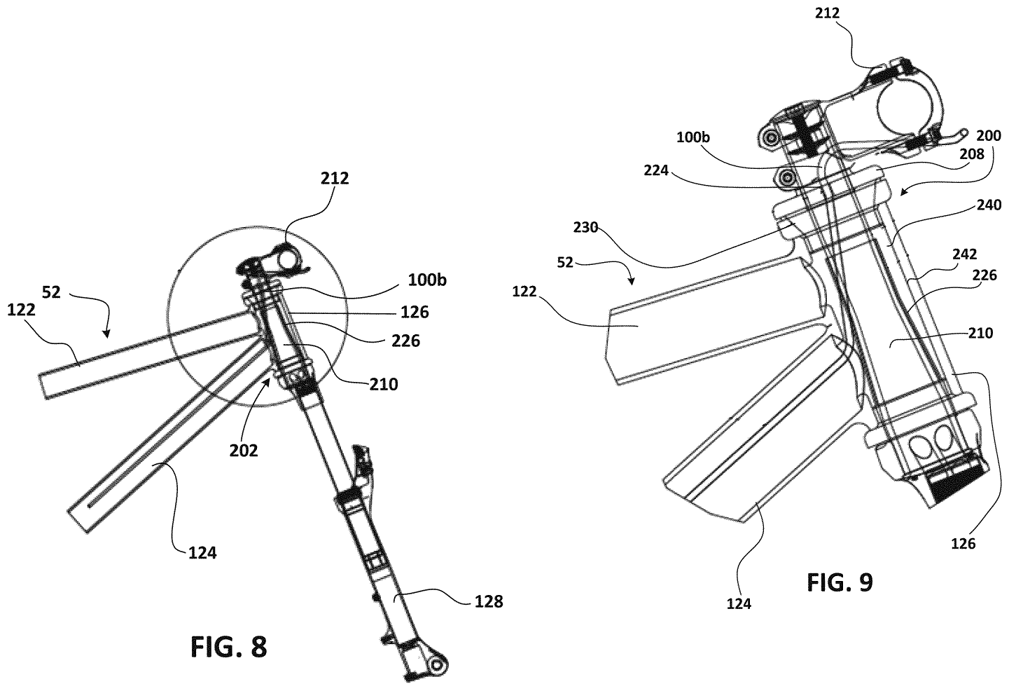

Referring to FIGS. 8 and 9, the headset cable router 200 may facilitate routing of the control lines 100 through the steering assembly 202 and into, for example, the down tube 124. In another embodiment, the headset cable router 200 facilitates routing of the control lines 100 through the steering assembly 202 and into the top tube 122. In yet another embodiment, the headset cable router 200 facilitates routing of some of the control lines 100 into the top tube 122, and facilitates routing of some of the control lines 100 into the down tube 124.

The control lines 100 come off the handlebars 68 (not shown) from one or more control devices (e.g., for brake(s), derailleur(s), sensor(s)), run alongside opposite sides of the stem 212, respectively, and into the ports 224 in the headset cap 208. The control lines 100 pass through the upper cup clearance 230, pass between a volume 240 between the steerer sheath 226 and an inner wall 242 (e.g., an inner surface) of the head tube 126 of the frame 52, and enter the down tube 124, for example, of the frame 52 of the bicycle 50.

The steerer sheath 226 creates a low friction barrier between the steerer tube 210 of the fork 128 and the control lines 100. The steerer sheath 226 may be made of any number of materials including, for example, plastic, polytetrafluoroethylene (PTFE), carbon fiber, polymer, an elastic material, a smooth metal, or another material. A wet or dry lubricant may be applied to an outer surface of the steerer sheath 226. In one embodiment, the steerer sheath 226 is formed by a coating on the steerer sheath 226. For example, the steerer sheath 226 may be a hard flame-sprayed ceramic of a soft, tough polymer.

The steerer sheath 226 may be fixedly or rotationally attached to the upper cup 204, the lower cup 206, or both the upper cup 204 and the lower cup 206 of the headset 130. The steer sheath 226 may be attached to the upper cup 204 and/or the lower cup 206 of the headset 130 in any number of ways including, for example, with an adhesive. In one embodiment, a soft interface (e.g., as a tolerance ring) disposed between bearings of the upper cup 204 and/or the lower cup 206 of the headset 130 and the steerer tube 210 of the fork 128 may be used to fix the steerer sheath 226 to the headset 130. With the steerer sheath 226 in place, the control lines 100 are unable to rub or wear against the steerer tube 210 of the fork 128.

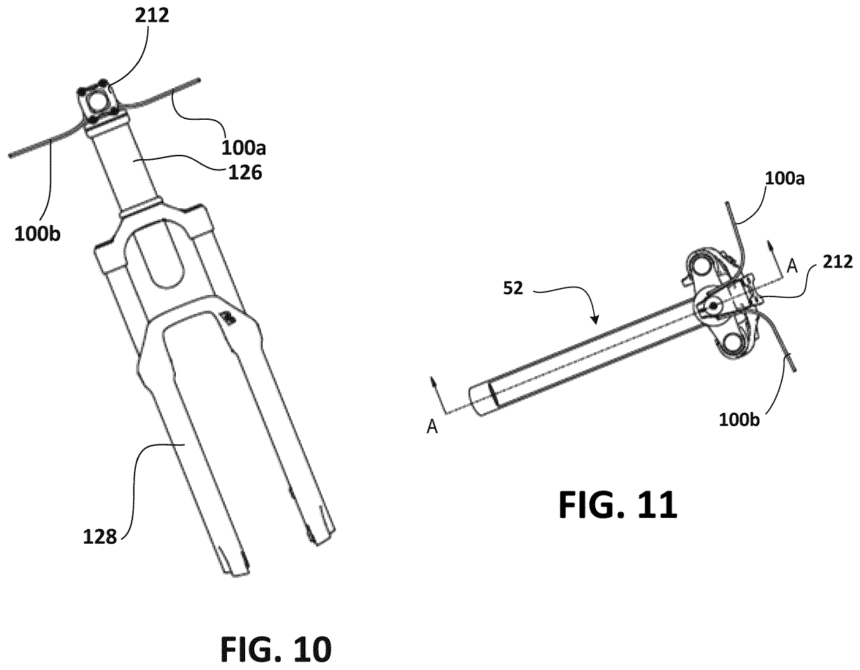

In the embodiment shown in FIGS. 10-13, the steerer sheath 226 is attached to the lower cup 206 of the headset 130. The steerer sheath 226 may be thin walled (e.g., 4 mm, 5 mm, 8 mm, or 10 mm). The steerer sheath 226 may be any number of shapes. For example, the steerer sheath 226 may be a hollow cylinder, though other shapes may be provided. In the embodiment shown in FIGS. 10-13, the steerer sheath 226 is tapered and closely offset from the steerer tube 210 of the fork 128 to maximize radial clearances and access to the head tube 126. In another embodiment, the steerer sheath 226 is non-tapered and/or is in contact with the steerer tube 210 of the fork 128.

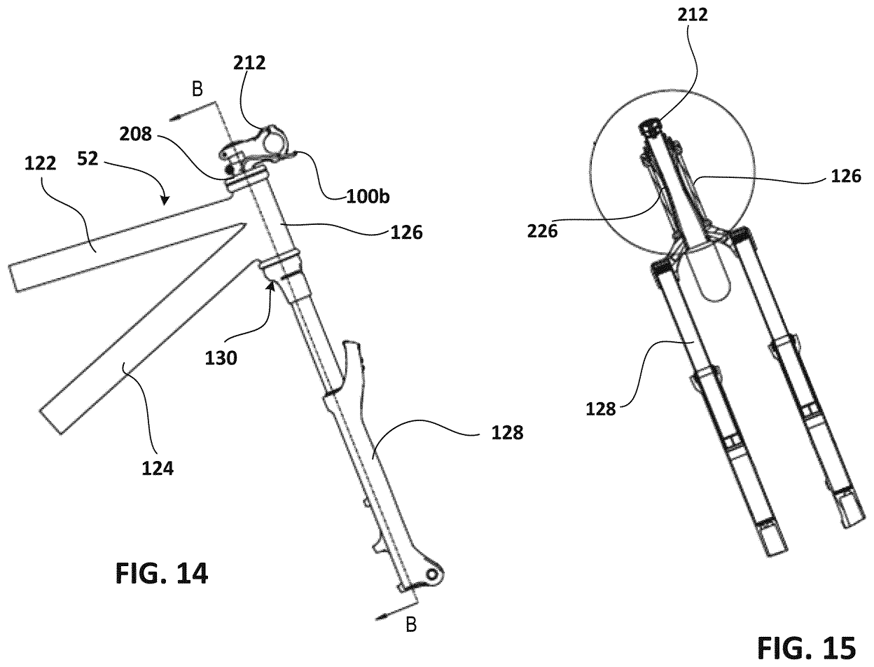

Referring to FIGS. 14-16, with the first control line 100a and the second control line 100b entering the ports 224 through the headset cap 208 at opposite sides of the stem 212, respectively, the first control line 100a and the second control line 100b wrap around the steerer sheath 226 and exit the head tube 126 (e.g., into the down tube 124 of the frame 52) towards the rear of the head tube 126 (e.g., in a direction facing away from the stem 212). In one embodiment, the first control line 100a and the second control line 100b may wrap around a front of the steerer sheath 226 (e.g., a portion of the steerer sheath 226 facing away from the top tube 122 and the down tube 124 of the frame 52 of the bicycle 50) one or more time before exiting the head tube 126 towards the rear of the head tube 126. In another embodiment, the first control line 100a and/or the second control line 100b enters the headset cap 208 towards the back of the stem 212, and the first control line 100a and/or the second control line 100b may exit the head tube 126 without wrapping around the steerer sheath 226.

Referring to FIGS. 17-20, the steerer sheath 226 may have a smooth outer wall. In another embodiment, however, an outer surface 244 of the steerer sheath 226 may include curved or spiral channels to hold the control lines 100 in place. The steerer sheath 226 of the embodiment of FIGS. 17-20 has as a closed tube geometry. In another embodiment, however, the steerer sheath 226 has an opening or a scam along a length of the steerer sheath 226 to case installation.

The steerer sheath 226 may be flexible or rigid. In one embodiment, the steerer sheath 226 is made from injected molded polymer with text descriptions on the outer surface 244 of the steerer sheath 226.

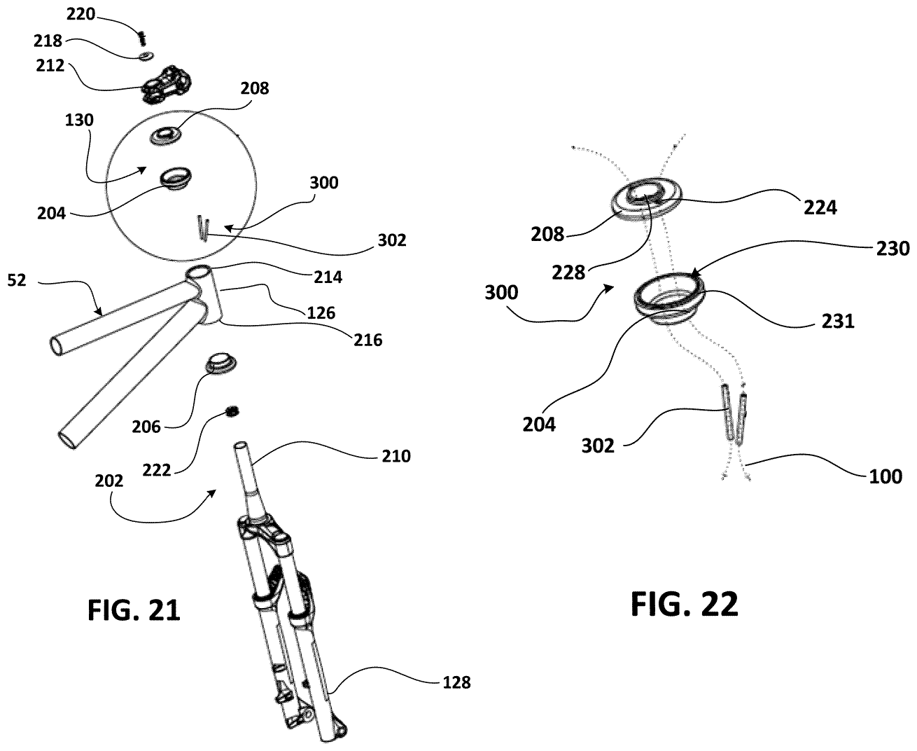

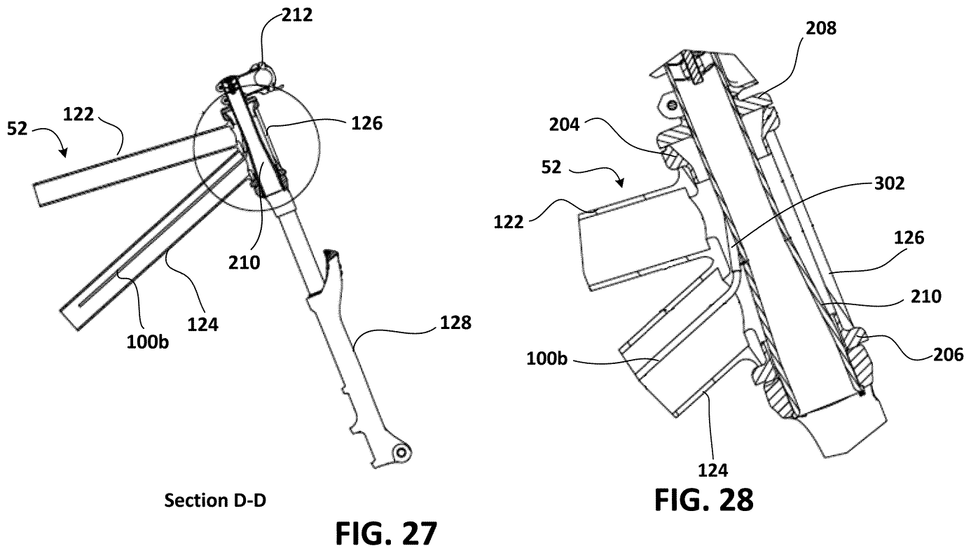

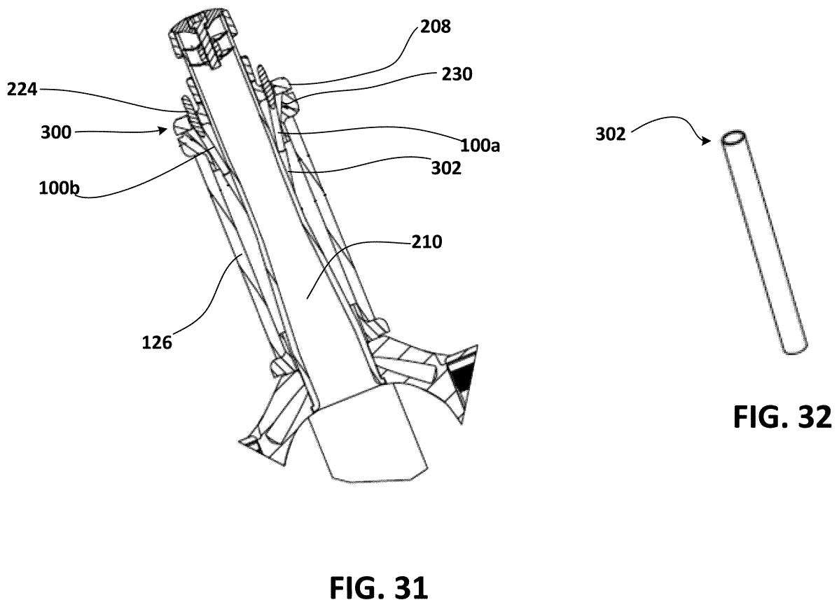

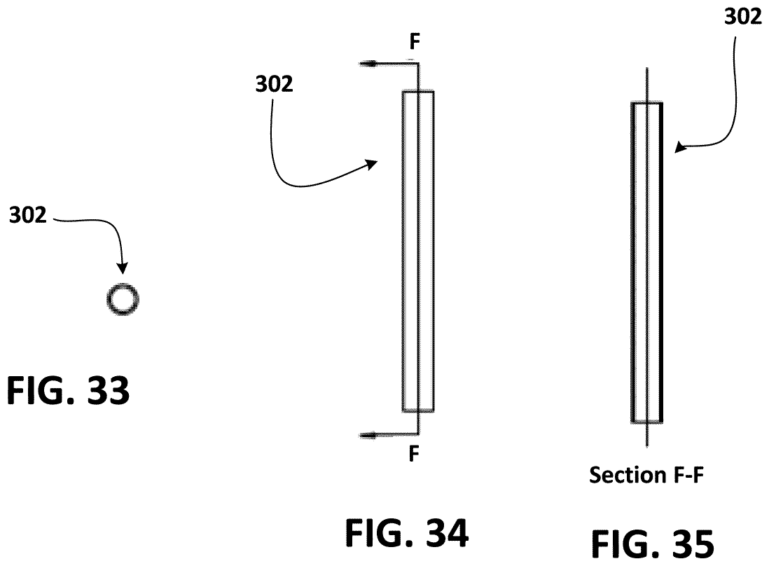

FIGS. 21-35 illustrate a second embodiment of a headset cable router 300 that may be used to route the control lines 100 into and through at least a portion of the frame 52 of the bicycle 50. Referring to FIG. 21, the steering assembly 202 of the bicycle 50, for example, includes the same components (e.g., the fork 128, the headset 130, and the portion (e.g., the head tube 126) of the frame 52 of the bicycle 50). The fork 128 is rotatably attachable to the frame 52 (e.g., the head tube 126 of the frame 52) with the headset 130.

Referring to FIG. 22, the headset cable router 300 includes the same components as the headset cable router 200, other than one or more line sheaths 302 replacing the steerer sheath 226. Like the embodiment shown in FIG. 3, the control lines 100 extend through the ports 224 in the headset cap 208, and through the upper cup clearance 230. In the embodiment shown in FIG. 22, however, the control lines 100 extend through corresponding line sheaths 302, respectively, instead of along an outer surface of the steerer sheath 226, as shown in the embodiment of FIG. 3.

In one embodiment, the headset cable router 300 includes both the line sheaths 302 of the embodiments shown in FIGS. 21-35 and the steerer sheath 226 of the embodiments shown in FIGS. 2-20. In such a configuration, the control lines 100 are installed through the line sheaths 302, and the line sheaths 302 extend through the head tube 126 of the frame 52 of the bicycle 50 outside of the steerer sheath 226.

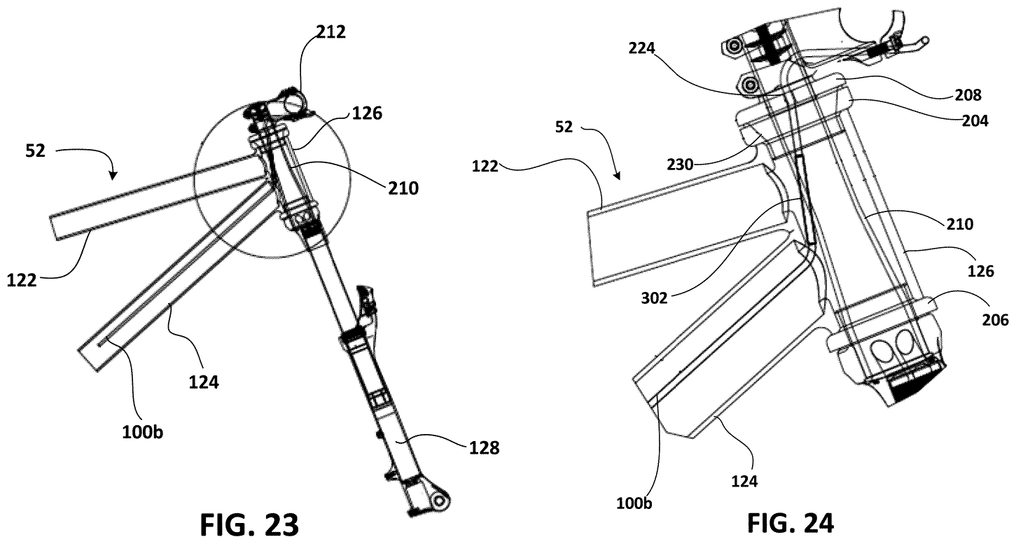

Referring to FIGS. 23 and 24, the line sheaths 302 over the control lines 100 act as low friction barriers between the steerer tube 210 of the fork 128 and the control lines 100. The line sheaths 302 may be made of any number of materials including, for example, plastic, Teflon, carbon fiber, polymer, an elastic material, a smooth metal, or another material. A wet or dry lubricant may be applied to outer surfaces of the line sheaths 302, respectively. The line sheaths 302 may be fixedly or rotationally attached to the upper cup 204, the lower cup 206, or both the upper cup 204 and the lower cup 206 of the headset 130. The line sheaths 302 may be attached to the upper cup 204 and/or the lower cup 206 of the headset 130 in any number of ways including, for example, with an adhesive. With the line sheaths 302 in place, the control lines 100 are unable to rub or wear against the steerer tube 210 of the fork 128.

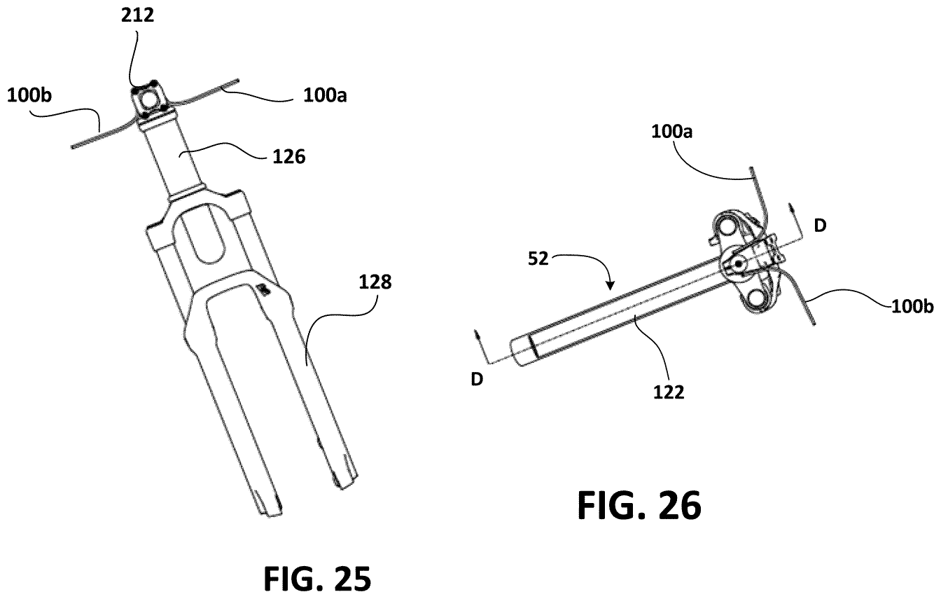

Referring to FIGS. 25-28, the line sheaths 302 act as a barrier against the steerer tube 210 of the fork 128 rotating relative to the frame 52 of the bicycle 50. The line sheaths 302 may be any number of sizes and/or shapes. For example, the line sheaths 302 may be hollow cylinders, though other shapes may be provided. The line sheaths 302 may have lengths long enough to enter the down tube 124 and/or the top tube 122, and/or enter the upper cup clearance 230 for added protection. The line sheaths 302 may have any number of wall thicknesses (e.g., 4 mm, 5, mm, 6 mm).

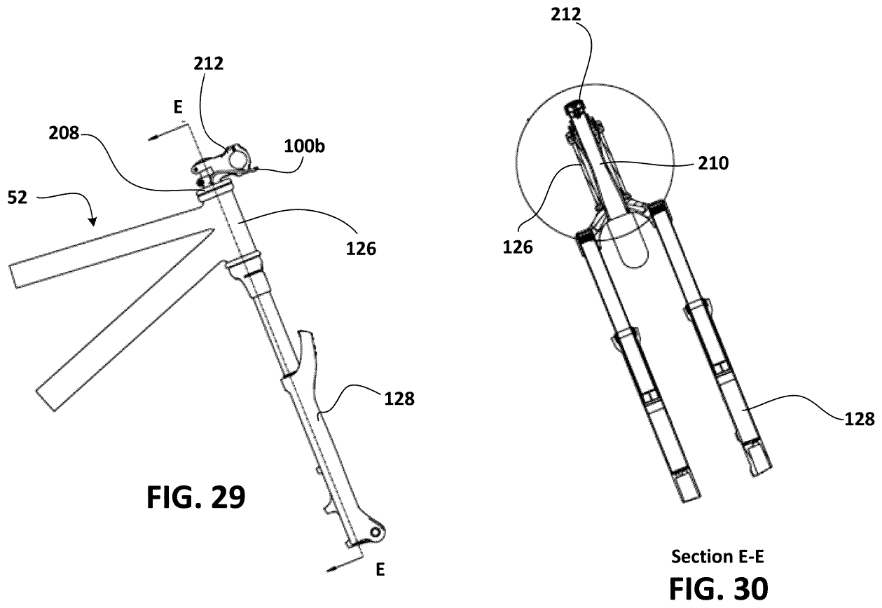

Referring to FIGS. 29-31, the upper cup clearance 230 of the headset cable router 300 allows for radial and rotation clearance for the control lines 100 with line sheaths 302 to move freely with rotation of the steerer tube 210 of the fork 128 relative to the frame 52 of the bicycle 50. The control lines 100 may enter the headset cap 208, via the ports 224, on opposite sides of the stem 212, or may enter the headset cap 208 towards the front or the back of the stem 212. The control lines 100 with line sheaths 302 wrap around the steerer tube 210 of the fork 128 to exit the head tube 126 of the frame 52 of the bicycle 50 towards the rear. In one embodiment, the control lines 100 with the line sheaths 302 may wrap around the front of the steerer tube 210 of the fork 128 one or more times before exiting the head tube 126 of the frame 52 of the bicycle 50 towards the rear.

Referring to FIGS. 32-35, a line sheath 302 may have a smooth outer wall. The line sheath 302 is shown as having a straight profile but may be configured with curvature or a spiral like shape to best fit in place. The line sheath 302 of the embodiment of FIGS. 32-35 has a closed tube geometry. In another embodiment, however, the line sheath 302 has an opening or a scam along a length of the line sheath 302 to case installation.

The line sheath 302 may be flexible or rigid. In one embodiment, the line sheath 302 is made from injected molded polymer with text descriptions on an outer surface 306 of the line sheath 302.

Although certain control devices, bicycles, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A control line router for a headset of a bicycle comprising:
a barrier disposed between a component of the bicycle and a segment of a control line within a headtube of the bicycle.

2. The control line router of claim 1, wherein the barrier is flexible.

3. The control line router of claim 1, wherein the component of the bicycle is a steerer tube of a fork, and the barrier is configured to surround, at least in part, the steerer tube.

4. The control line router of claim 3, wherein the barrier is a tapered tube offset from the steerer tube, the tapered tube configured so that the tapered tube does not contact the steerer tube.

5. The control line router of claim 3, wherein the barrier is attached to any one or both of an upper cup and a lower cup of the headset of the bicycle.

6. The control line router of claim 3, wherein the barrier contacts the steerer tube.

7. The control line router of claim 1, wherein the barrier is configured to surround the segment of the control line.

8. The control line router of claim 7, wherein the barrier extends into a top tube, a down tube, a stem, a fork, or any combination thereof.

9. The control line router of claim 1, wherein the barrier has an annular cross section.

10. The control line router of claim 9, wherein the barrier includes a seam along a length of the barrier.

11. The control line router of claim 1, the barrier comprising:
a steerer tube sheath configured to surround, at least in part, a steerer tube of a fork; and
a control line sheath configured to surround, at least in part, the segment of the control line.

12. The control line router of claim 1, wherein the barrier is made of one or a combination of a plastic, a polymer, a carbon fiber composite, a composite, PTFE, an elastic material, or a metal.

13. The control line router of claim 12, the barrier having an outer wall, the outer wall including a friction reducing coating, wherein the friction reducing coating comprises any one or a combination of a PTFE coating, a wet lubricant, or a dry lubricant.

14. The control line router of claim 1, the control line router further comprising a cap through which extends a steerer tube of a fork, the cap having one or more ports extending through the cap, wherein the control line extends through the cap via the one or more ports.

15. The control line router of claim 14, the control line router further comprising an upper cup having a clearance configured to allow for radial and/or rotational clearance for the control line.

16. The control line router of claim 1, wherein the control line is a hydraulic tube or a bowden cable.

17. A device for a bicycle comprising a barrier disposed between one or more components in a headtube of the bicycle.

18. The device of claim 17, wherein one of the one or more components is a steerer tube of a fork, and the barrier is configured to surround a section of the steerer tube.

19. The device of claim 17, wherein one of the one or more components is a control line, the barrier configured to surround a segment of the control line.

20. The device of claim 17, the barrier comprising at least two sheaths, wherein a first sheath is configured to surround a section of a steerer tube of a fork, and a second sheath is configured to surround a segment of a control line.
